(19) United States
(12) Patent Application Publication
(10) Pub. No.: US 2026/0056716 A1
(43) Pub. Date: Feb. 26, 2026

(54) FRAMEWORK-AGNOSTIC PLUGGABLE WEB-APPLICATION ARCHITECTURE FOR LOW-CODE DEVELOPMENT

(71) Applicant: ADP, INC, Roseland, NJ (US)

(72) Inventor: Yan Qin, Weehawken, NJ (US)

(73) Assignee: ADP, INC, Roseland, NJ (US)

(21) Appl. No.: 18/809,878

(22) Filed: Aug. 20, 2024

(51) Int. Cl. G06F 8/34

(52) U.S. Cl. CPC G06F 8/34

(57) ABSTRACT

Systems and methods for an integrated development environment (IDE) are provided. The system may include a common core and a model-view-adapter (MVA) plugin. The common core is executable to transfer data objects to and/or from a metadata database over a network, where the common core is executable within an IDE configured to customize a customizable application, and where application logic of the customizable application is configured to customize aspects of the customizable application based on the data objects. The MVA plugin is executable to generate a visualization of and/or edit a data object of a data object type. The MVA plugin includes a MDO controller, a MDO view, and a MDO adapter. The MDO controller is executable to control the data object in response to IDE events received from the MDO adapter. The MDO view is executable generate the visualization of the data object via the MDO adapter.

### TECHNICAL FIELD

This application relates to integrated development environments (IDEs) and, in particular, to plugins for IDEs.

### BACKGROUND

Present plugin systems suffer from a variety of drawbacks, limitations, and disadvantages. Accordingly, there is a need for inventive systems, methods, components, and apparatuses described herein.

### BRIEF DESCRIPTION OF THE DRAWINGS

The examples may be better understood with reference to the following drawings and description. The components in the figures are not necessarily to scale. Moreover, in the figures, like-referenced numerals designate corresponding parts throughout the different views.

FIG. 1 illustrates an example of a system for a framework-agnostic pluggable application architecture for low-code development;

FIG. 2 illustrates an example of a graphical user interface of the IDE in which the IDE generates a visualization of one of the data objects in a default manner;

FIG. 3 illustrates an example of the graphical user interface of the IDE in which the IDE relies on a plugin to generate a visualization of and/or edit a data object of a data object type;

FIG. 4 illustrates example structures of a MVA plugin and the legacy plugin;

FIG. 6 illustrates an example state diagram of the system;

FIG. 7 illustrates a flow diagram of example logic for operational state detection;

FIG. 8 illustrates a flow diagram of example logic for the system;

FIG. 9 illustrates an example of system hardware; and

FIG. 10 illustrates an example of JavaScript code using setTimeout( ) to accomplish various operations.

### DETAILED DESCRIPTION

In one example, a computer readable storage medium is provided comprising computer executable instructions, the computer executable instructions comprising: a common core and a model-view-adapter (MVA) plugin. The common core is executable to transfer data objects to and/or from a metadata database over a network, where the common core is executable within an integrated development environment (IDE) configured to customize a customizable application, and where application logic of the customizable application is configured to customize aspects of the customizable application based on the data objects stored in the metadata database. The MVA plugin is for the IDE and is executable to generate a visualization of and/or edit a data object of a data object type, the data object included in the data objects, the MVA plugin comprising a MDO controller, a MDO view, and a MDO adapter. The MDO controller is executable to control the data object in response to an IDE event received from the MDO adapter. The MDO view is executable to handle a user input event received from the MDO adapter and to generate the visualization of the data object via the MDO adapter. The MDO adapter is executable to: connect the MDO view and the MDO controller; provide events and data to the MDO view and the MDO controller; invoke a user interface layer of the IDE on behalf of the MDO view for the visualization of the data object; and transfer the data object to and/or from the metadata database via the common core.

One technical advantage of the systems and methods described below may be an improved speed performance of the IDE. Alternatively or in addition, a technical advantage may be an improved stability of the IDE. Web-based graphical user interface layers may be unidirectional data flow frameworks. For example, React.js is one such common unidirectional data flow framework. A major benefit of the unidirectional data flow approach is that data flows throughout the application in a single direction, making the application easier to debug, less prone to errors, and more efficient. Surprisingly, the use of plugins in an IDE implemented with a unidirectional data flow framework may result in the opposite. Some examples of the systems and methods described below provide a novel application of a model-view-adapter pattern at a local level to a unidirectional data flow framework, resulting in a plugin system that may be more efficient, controllable, and extensible, as well as more stable and performant.

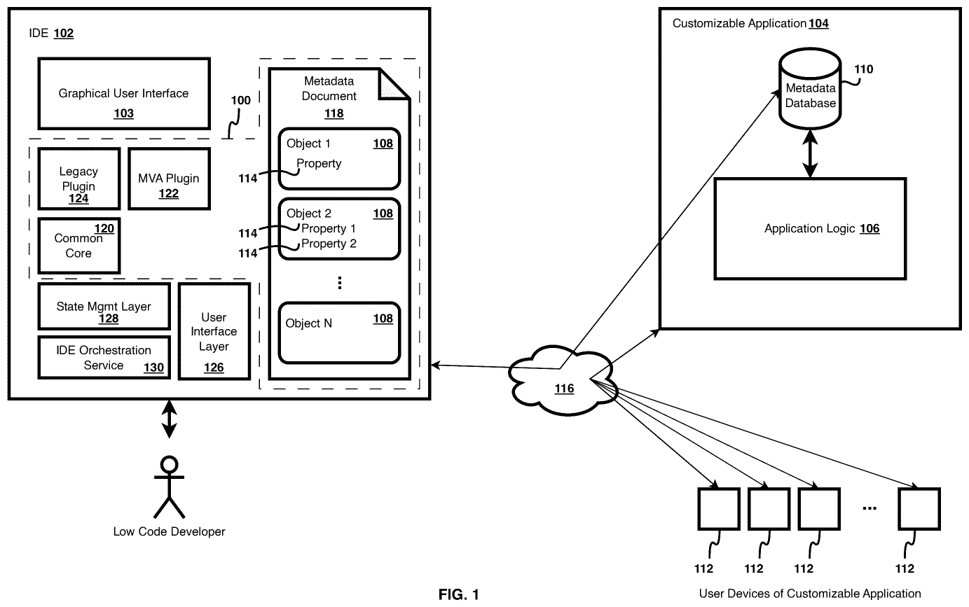

FIG. 1 illustrates an example of a system 100 for a framework-agnostic pluggable application architecture for low-code development. In particular, the system 100 is for an integrated development environment (IDE) 102 configured to customize a customizable application 104. The IDE 102 may be any software application having a graphical user interface 103 that enables programmers to develop software code and provides support for plugins. Examples of the IDE 102 include Visual Studio, Eclipse, IntelliJ IDEA, NetBeans, Atom, and any other IDE that supports plugins.

Plugins are software components that extend the functionality of the IDE 102. Plugins are extensions that allow customization of the IDE 102 without altering the primary codebase of the IDE 102.

The customizable application 104 may be any software application that includes application logic 106 configured to customize aspects of the customizable application 104 based on data objects 108 stored in a metadata database 110. Examples of customizable aspects may include a user interface layout (for example, web layout), a rest service, and a database schema. The customizable application 104 and the IDE 102 together may be considered a low-code development platform (LCDP). Low-code development is a visual software development approach that simplifies the creation of applications by limiting the need for traditional hand-coding. The customizable application 104 may be a web application, a mobile application, a desktop application, a backend application, or any other type of software application.

In the example illustrated in FIG. 1, user devices 112 are shown in communication with the customizable application 104 over a network 116. In some examples, the user devices 112 may include a web browser that accesses the customizable application 104 as a web application.

As indicated above, the application logic 106 is configured to customize aspects of the customizable application 104 based on the data objects 108. Each of the data objects 108 may include a set of properties 114 (attributes or values) that represent an aspect, a characteristic, a quality, and/or a descriptor of a corresponding object. More specifically, each of the data objects 108 may include zero, one, or additional properties 114 that may affect the customizable aspects of the customizable application 104. In some examples, the properties 114 may also be—or include—one or more data objects. By default, the IDE 102 may display the data objects 108 and their properties 114 in the graphical user interface 103 in a preconfigured, predetermined, and/or default manner.

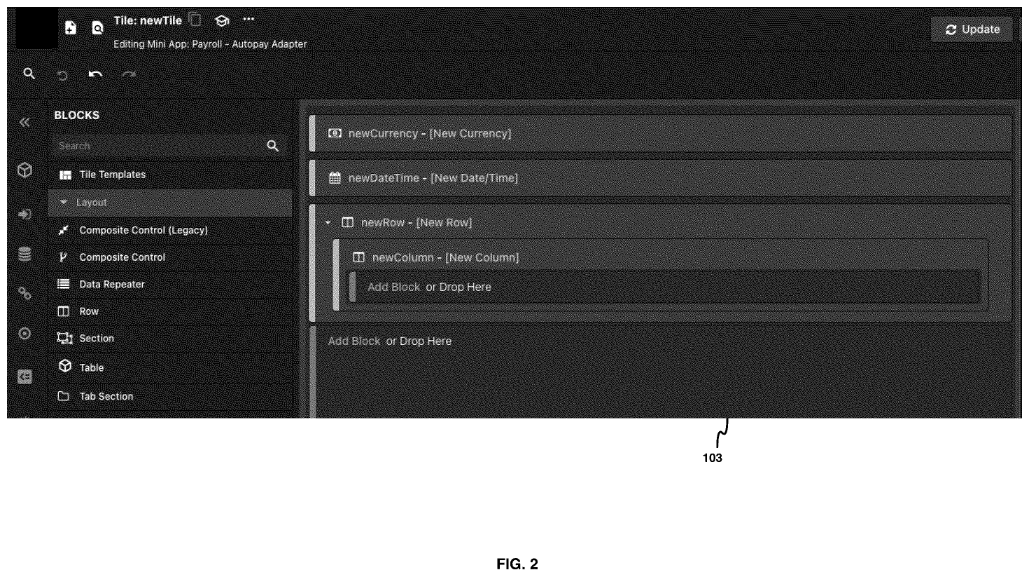

FIG. 2 illustrates an example of the graphical user interface 103 of the IDE 102 in which the IDE 102 generates a visualization of one of the data objects 108 in a default manner. In the illustrated example, the data object is a tile data object, which defines a layout of graphical user interface elements to be displayed on a graphical user interface of the customizable application 104. The default manner in the example of FIG. 2 is a generally hierarchical visualization of the data objects 108 and the properties 114 therein. Note that the tile data object edited in graphical user interface of the IDE 102 affects the aspect of how a graphical user interface of the customizable application 104 is ultimately displayed on the user devices 112.

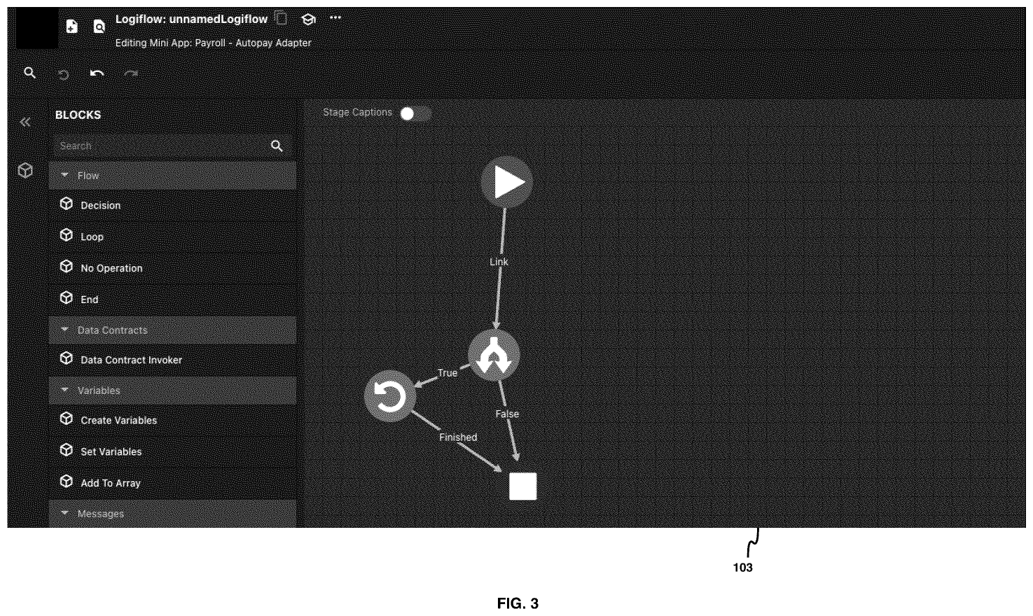

In contrast to FIG. 2, FIG. 3 illustrates an example of the graphical user interface 103 of the IDE 102 in which the IDE 102 relies on a plugin to generate a visualization of and/or edit a data object of a data object type. In the illustrated example, the data object type handled by the plugin is a logic flow data object type. The example of the visualization of the logic flow data object includes icons representing various operations, such as start, branch, repeat, and stop. The visualization of the logic flow data object also includes connectors that connect icons and represent states and/or conditions, such as the connectors labeled link, true, false, and finished, respectively. However, the plugin for the logic flow data object is just one example. The plugin may be implemented to generate a visualization of and/or edit a data object of any other data object type, such as text, number, date, or even any custom data type.

Referring again to FIG. 1, the IDE 102 in the illustrated example includes the graphical user interface 103, a user interface layer 126, a state management layer 128, and an IDE orchestration service 130. The user interface layer 126 may be any software component configured to generate a graphical user interface of a software application such as the IDE 102. Examples of the user interface layer 126 include React, React Native, Inferno, Lit, Svelte, Htmx, Aurelia, UIKit, SuiftUI, AppKit, and Jetpack Compose. The state management layer 128 includes a library configured to manage an application state of a software application such as the IDE 102. The application state may be any data to be shared across multiple parts of the application and/or is to be retained between user sessions. Examples of the state management layer 128 include Redux, MobX, Zustand, and React Query. The IDE orchestration service 130 is any service of the IDE 102 that is configured to coordinate execution of the plugins on behalf of the IDE 102.

The system 100 for the framework-agnostic pluggable application architecture in FIG. 1 includes a metadata document 118, a common core 120, and plugins, such a model-view-adapter (MVA) plugin 122 and a legacy plugin 124. The metadata document 118 comprises the data objects 108, which may be all or a subset of the data objects 108 stored in the metadata database 110. The application state of the IDE 102 may include the metadata document 118, and as such, may be managed by the state management layer 128. The common core 120 includes one or more programmatic methods specific to customization of the customizable application 104. The programmatic methods may be usable by the plugins 122 and 124, and hence provides services common to the plugins 122 and 124. For example, the common core 120 may include programmatic methods configured to: load, edit, validate, and save the metadata document 118; fetch and execute IDE behaviors; fetch and apply custom IDE logic and assets; and/or handle lifecycle events. To load and/or save the data objects 108, the common core 120 is configured to transfer the data objects 108 in the metadata document 118 to and/or from the metadata database 110 over the network 116. The transfer of the data objects 108 may be a transfer of all or a portion of the metadata document 118.

The MVA plugin 122 is configured to generate a visualization of and/or edit a first data object of a first data object type, where the first data object is included in the data objects 108 of the metadata document 118. Similarly, the legacy plugin 124 is configured to generate a visualization of and/or edit a second data object of a second data object type, where the second data object is included in the data objects 108 of the metadata document 118.

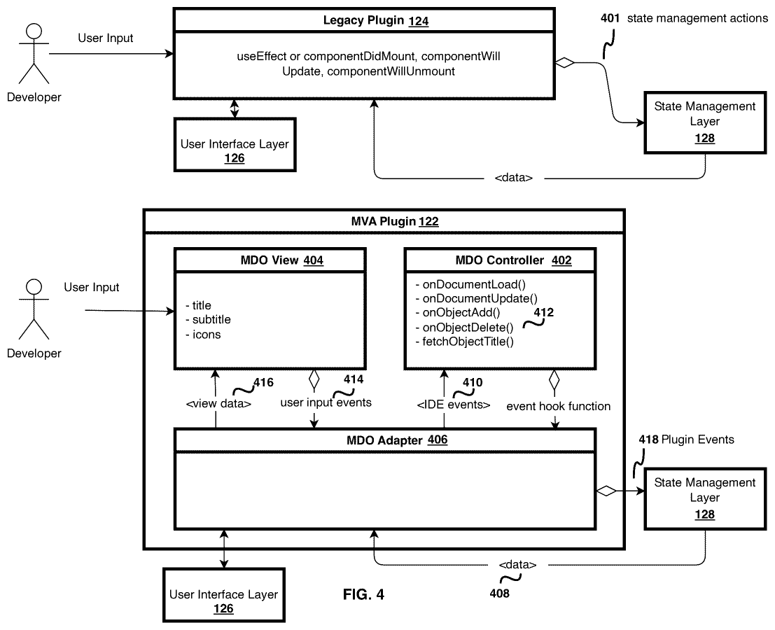

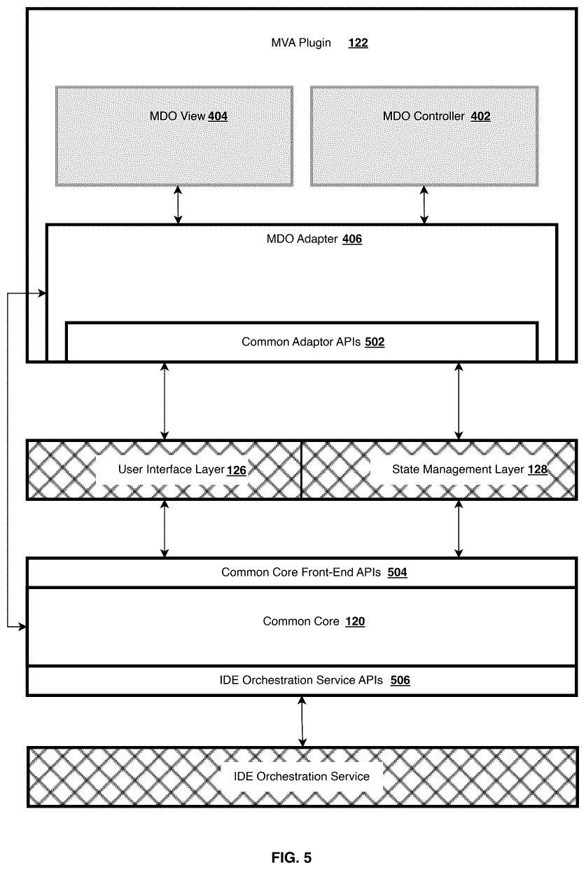

However, the overall structure of the MVA plugin 122 is different than the overall structure of the legacy plugin 124. FIG. 4 illustrates example structures of the MVA plugin 122 and the legacy plugin 124 in a side-by-side comparison.

Structure wise, the legacy plugin 124 is configured to generate a visualization of and/or edit the second data object directly via the user interface layer 126. Accordingly, the legacy plugin 124 may implement an API invoked by the user interface layer 126, and the legacy plugin 124 may invoke an API of the user interface layer 126. The API implemented by the legacy plugin 124 and invoked by the user interface layer 126 may include, for example, the programmatic methods: useEffect( ) or componentDidMount( ), componentWillUpdate( ), and componentWillUnmount( ) as shown in the legacy plugin 124 of FIG. 4. The programmatic methods in the illustrated example are included in a component API invoked by React, which is an example of the user interface layer 126. In other words, the illustrated example of the legacy plugin 124 is implemented as a React component.

Further regarding the structure of the legacy plugin 124 in FIG. 4, the legacy plugin 124 is configured to directly invoke the state management layer 128 and/or be invoked by the state management layer 128 in state management actions 401. For example, the legacy plugin 124 is configured to transfer the second data object directly to and/or from the state management layer 128. In addition, the legacy plugin 124 is configured to invoke the common core 120 for network operations. For example, the legacy plugin 124 is configured to transfer the first data object to and/or from the metadata database 110 via the common core 120.

The structure of the legacy plugin 124 is a logical approach. Surprisingly, if many of the plugins have the structure of the legacy plugin 124, the overall performance of the IDE 102 may suffer. The structure of the legacy plugin 124 may result in additional disadvantages, such as: simple plugin creation may require using a substantial amount of boilerplate code; the legacy plugins may not work well with each other; and troubleshooting issues may be difficult and unintuitive.

The system 100 for the framework-agnostic pluggable application architecture provides a novel solution to one or more of the above-identified issues associated with the structure of the legacy plugin 124. The system 100 provides support for plugins structured based on framework-agnostic lifecycles and business logic specific to the data objects 108 and/or the metadata document 118 for the customizable application 104. In contrast, plugins like the legacy plugin 124 have a structure dictated by the user interface layer 126 and/or the state management layer 128 of the IDE 102.

The framework-agnostic pluggable application architecture of the system 100 imposes a model-view-adapter pattern to at least a subset of the plugins. The MVA plugin 122 in FIG. 4 includes a metadata object (MDO) model controller 402 (also referred to herein as the MDO controller 402), a MDO view 404, and a MDO adapter 406. Table 1 below provides a description of the components of the MVA plugin 122.

TABLE 1

| Component | Description |
|---|---|
| MDO controller 402 | The MDO controller 402 is configured to control data |
| | 408, such as any of the data objects 108 associated |
| | with the MVA plugin 122, in reaction to IDE events 410 |
| | received from the MDO adapter 406. The MDO |
| | controller 402 implements a data API 412, which may |
| | be invoked by the MDO adapter 406. Examples of |
| | programmatic methods of the data API 412 may |
| | include: |
| | onDocumentLoad( ) |
| | onDocumentUpdate( ) |
| | onObjectAdd( ) |
| | onObjectDelete( ) |
| | fetchObjectTitle( ) |
| | The MDO controller 402 may have no knowledge of the |
| | user interface layer 126 of the IDE 102. |
| MDO view 404 | The MDO view 404 is a presentational component that |
| | may translate user input and/or visualize data. |
| | Specifically, the MDO view 404 is configured to handle |
| | one or more user input events 414 received from the |
| | MDO adapter 406 and to generate, via the MDO |
| | adapter 406 and/or the common core 120, a |
| | visualization of view data 416 received from the MDO |
| | adapter 406. The view data 416 may include, for |
| | example, any of the data objects 108 associated with |
| | the MVA plugin 122. |
| MDO adapter 406 | The MDO adapter 406 is configured to connect the |
| | MDO view 404 and the MDO controller 402. For |
| | example, an instance of the MDO adapter 406 may |
| | include pointers to corresponding instances of the MDO |
| | view 404 and the MDO controller 402. In addition, the |
| | MDO adapter 406 may be configured to provide the |
| | view data 416 and the user input events 414 to the MDO |
| | view 404. The MDO adapter 406 is further configured to |
| | provide the data 408 and the IDE events 410 to the |
| | MDO controller 402. |

The MDO adapter 406 may be further configured to: invoke the user interface layer 126 on behalf of the MDO view 404 for the visualization of the view data 416; receive plugin events 418 from the state management layer 128; transfer any of the data objects 108 associated with the MVA plugin 122 to and/or from the state management layer 128; and transfer any of the data objects 108 associated with the MVA plugin 122 to and/or from the metadata database 110 via the common core 120.

The plugin events 418 may be any events from the state management layer 128 issued to any of the plugins 122 and 124. Examples may include data object deletion, data object changed, and data object added.

In some examples, base implementations of the MDO controller 402, the MDO view 404, and the MDO adapter 406 may be provided such that a custom plugin may be created by overriding the base implementation of the MDO controller 402, the MDO view 404, or a combination thereof. Custom plugins may include plugins for header actions, a toolbox, a canvas, properties, a menu, a copy & paste action, or any other feature.

A non-customized implementation of the MDO adapter 406 may provide a common code path for customized implementations of the MDO controller 402 or the MDO view 404. The common code path enables centralized checkpoints for profiling, debugging, and logging of custom plugins.

FIG. 5 illustrates including common adapter APIs 502, common core front-end APIs 504, and IDE orchestration service APIs 506 in the system 100 for the framework-agnostic pluggable application architecture. The common adapter APIs 502, the common core front-end APIs 504, and the IDE orchestration service APIs 506 simplify replacing the IDE 102, the state management layer 128, and/or the user interface layer 126 by focusing code changes needed for the replacement to the implementations of the common adapter APIs 502, the common core front-end APIs 504, and the IDE orchestration service APIs 506. Furthermore, customizations of the MVA plugin 122 may be concentrated in the MDO view 404 and/or the MDO controller 402.

The system 100 for the framework-agnostic pluggable application architecture has clear operational states. Advantages of having clear operational states may include better control over data flow, better application-level interface for testing, better troubleshooting capability, better extensibility, and/or framework-agnostic code in the MDO view 404 and the MDO controller 402. The system 100 has framework-agnostic lifecycles and business logic specific to the data objects 108 and/or the metadata document 118 instead of lifecycles that are specific to the user interface layer 126.

Application lifecycles may include one or more application events. A chain of the application events may complete an application life cycle. Completion of a life-cycle event may define an operational state or contribute to an operational state.

In the system 100 for the framework-agnostic pluggable application architecture, an application event has three sub-events: a pre-event, an on-event, and a post-event. The pre-event is triggered prior to the application event starting. The on-event is triggered at the application event. The post-event is triggered after the application event completes.

The application events may be grouped into primarily two types of events based on the scope. One type of event is a global event, and another type of event is a local event.

Global events are events triggered at a global scope and may provide insights into the status of an application. The global events may have the following characteristics: triggered from the main application level, and are atomic, meaning a single global event is happening at a time until the event is completed. One example of a global event is a document loading event, which is when the metadata document 118 is loaded.

Local events are events triggered at a local scope and driven by global events in most cases. The local events may have the following characteristics: triggered from a local technical component level and are atomic only on a local level. In other words, from a local component perspective, the event is atomic, but from the main application level, there may not be any limitation regarding the instances of the event. One example of a local event is a metadata block loading event, which is the loading of a block within the metadata document 118.

To integrate or establish the relationship between global events and local events, there is a general rule based on the concepts mentioned above. The general rule is that global events are the driving force of all other events. Consequently, global events are the starting point of an event chain. The starting point of a local event is triggered at the “on-event” of the global event. The global event transitions into “post-event” after the local events that the global event drove have been completed. More generally, for a parent event, the post-event of the parent event is reached after all child events have been completed.

Table 2 below provides examples of events in the system 100 and the corresponding types of the events. The system 100 may have fewer, additional, and/or different events than listed in Table 2.

TABLE 2

| | Event | | |
|---|---|---|---|
| Event Name | Type | Sub-events | Note |
| bootstrap | global | preBootstrap | fetching auth token, feature |
| | | | flags, MASK, MAS |
| | | onBootstrap | fetching type definitions, custom |
| | | | logic source |
| | | postBootstrap | |
| documentLoad | global | preDocumentLoad | fetching the metadata document |
| | | | 118 or a default version of the |
| | | | metadata document 118 |
| | | onDocumentLoad | triggering applicable local events |
| | | postDocumentLoad | |
| | | preDocumentUpdate | |
| documentUpdate | global | onDocumentUpdate | triggering applicable local events |
| | | postDocumentUpdate | |
| documentSave | global | preDocumentSave | fetching result of the metadata |
| | | | validation result |
| | | on DocumentSave | storing (POST/PUT) metadata |
| | | | as the metadata document 118 |
| | | postDocumentSave | |
| blockLoad | local | preBlockLoad | fetching remote metadata if |
| | | | needed |
| | | onBlockLoad | |
| | | postBlockLoad | fetching and executing behaviors |
| blockUpdate | local | preBlockUpdate | |
| | | onBlockUpdate | |
| | | postBlockUpdate | fetching and executing behaviors |
| blockDelete | local | preBlockDelete | |
| | | onBlockDelete | |
| | | postBlockDelete | |

The block actions are actions operating on one or more of the data objects 108. Accordingly, the events corresponding to block actions in the above example are events specific to the data objects 108 and/or the metadata document 118. The data API 412 implemented by the MDO controller 402 may include one or more programmatic methods corresponding to one or more of the events and/or the sub-events specific to the data objects 108 and/or the metadata document 118. For example, the data API 412 may have a programmatic method configured to be invoked in response to the metadata document 118 being loaded, such as onDocumentLoad( ). As another example, the data API 412 may have a programmatic method configured to be invoked in response to an update to the metadata document 118, such as onDocumentUpdate( ).

Plugins having the structure of the MVA plugin 122 leverage the lifecycles and business logic to specific to the data objects 108 and/or the metadata document 118, which results in an ability to accurately determine the operational state of the application. This is due to a good collaboration between local events (such as block load event) and global events (such as the document load event).

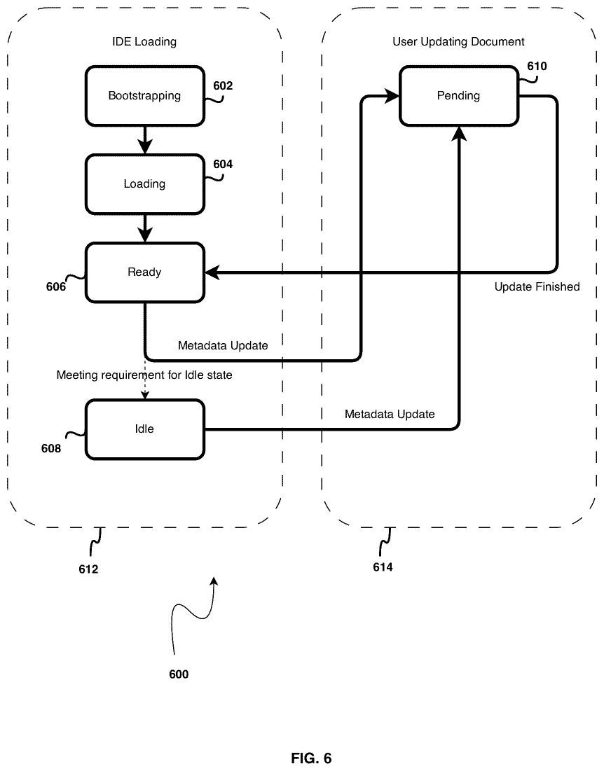

FIG. 6 illustrates an example state diagram 600 of the system 100. The operational states shown in the example include a bootstrapping state 602, a document loading state 604, a ready state 606, an idle state 608, and a pending update state 610. The system 100 may include additional, fewer, and different operational states than illustrated.

A first group 612 of operational states relate to the IDE 102 loading or starting up. A second group 614 of operational states relate to a user updating the metadata document 118.

The bootstrapping state 602 is an operational state during which initial configuration information is fetched from the metadata database 110. The document loading state 604 may be an operational state during which the metadata document 118 is loaded into memory and initialized. The document loading state 604 ends when, for example, the global onDocumentLoad event completes. The ready state 606 is reached, for example, after the global postDocumentLoad event completes. In the ready state 606, the IDE 102 is ready to receive user input. If no user input events 414 related to updating the metadata document 118 are being handled, then the idle state 608 may be reached. Alternatively, if the user input events 414 related to updating the metadata document 118 are being handled, then the pending update state 610 is reached. After, for example, all postBlockUpdates and postBlockDeletes complete, the operational state may move from the pending update state 610 to the idle state 608. In the idle state 608, the IDE 102 is ready to receive user inputs, and the user input events 414 related to updating the data objects 108 and the metadata document 118 have completed.

Accordingly, the ability to determine the operational state of the IDE 102 is aided by the framework-agnostic lifecycles as well as the business logic and events specific to the data objects 108 and/or the metadata document 118. Because MVA plugins like the MVA plugin 122 are structured around the framework-agnostic events and lifecycles of the system 100, the ability to determine the operational state of the IDE 102 is simplified.

In contrast, plugins having the structure of the legacy plugin 124 make determining the operational state of the application difficult. This is primarily a result of the legacy plugin 124 having full control over the life cycle of the legacy plugin 124 and the data the legacy plugin 124 manages. Indeed, the loading behavior becomes unpredictable, as there are many permutations of different asynchronous and synchronous operations triggered without supervision from a core system of the IDE 102.

Converting legacy plugins like the legacy plugin 124 to a structure like the MVA plugin 122 is one possible solution. However, converting many legacy plugins to MVA plugins may be expensive and time consuming. Accordingly, novel operational state detection systems and methods are provided herein.

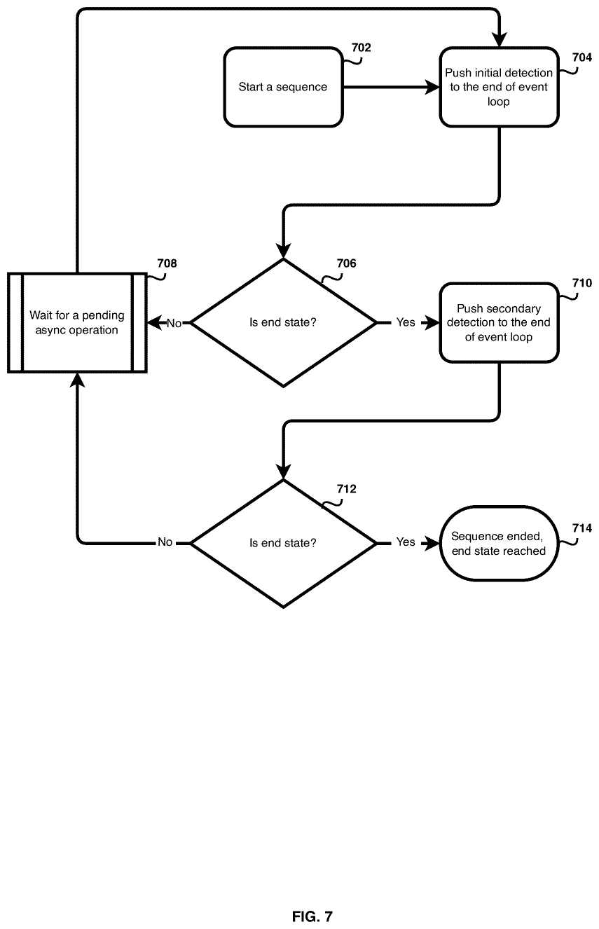

FIG. 7 illustrates a flow diagram of example logic for operational state detection. The logic may include additional, fewer, and/or different operations than illustrated in FIG. 7.

Operations may begin by starting (702) a sequence of detection operations. The legacy plugins, like the legacy plugin 124 shown in FIG. 4, transfer data such as the data objects 108 to and/or from the metadata database 110 via the common core 120 in a transfer operation. Therefore, the sequence of detection operations may be started (702) in response to any of the legacy plugins invoking a programmatic method of the common core 120 that transfers data to and/or from the metadata database 110. In some examples, the programmatic method of the common core 120 may only start (702) the sequence of detection operations if the data to be transferred includes one or more of the data objects 108.

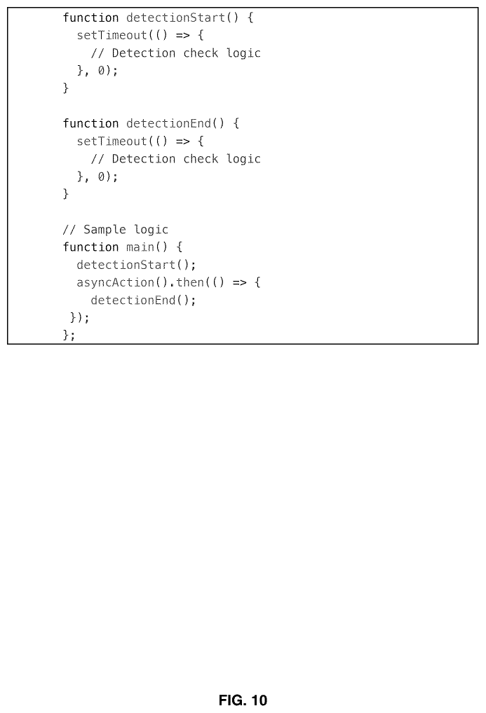

The programmatic method of the common core 120 may start (702) the sequence of detection operations by pushing (704) an initial detection operation to the end of an event loop of the IDE 102. For example, in JavaScript, the programmatic method of the common core 120 may invoke setTimeout( ) to push the initial detection operation to the end of the event loop. The programmatic method of the common core 120 may then begin the transfer of data to and/or from the metadata database 110 in an asynchronous network operation. FIG. 10 illustrates an example of how JavaScript code may use setTimeout( ) to accomplish such operations.

In some examples, such as the one in FIG. 10, when the asynchronous network operation is initiated, a corresponding callback function is placed in a callback queue. Later when the asynchronous network operation completes, the callback function is removed from the callback queue and the callback function is invoked. In alternative examples, when the asynchronous network operation completes, an exception is thrown or an interrupt is signaled, which may be handled.

Meanwhile, when the initial detection operation is eventually reached in the event loop, the initial detection operation is performed (706) as shown in FIG. 7. The initial detection operation checks if the end state is reached. An example of the end state is the idle state 608. The end state may be considered reached if there are no pending asynchronous network operations and synchronous operations that follow the asynchronous network operations are completed.

To determine if there are no pending asynchronous network operations, the common core 120 or other code may, for example, check whether any callback function is in the callback queue. In other examples, a data structure used by an event handler or by an interrupt handler may be checked to see if any asynchronous network operations are pending processing by the handler.

The synchronous operations are operations made by MVA plugins structured like the MVA plugin 122 to change the data objects 108 and/or the metadata document 118. Therefore, to determine that synchronous operations following the asynchronous network operations are completed, the common core 120 or other code may check that invocations of the one or more programmatic methods of the data API 412 corresponding to one or more events and/or sub-events specific to the data objects and/or the metadata document have completed.

If the initial detection operation (706) determines the end state has not been reached, then operations will proceed to wait until an asynchronous network operation completes (708). As noted above, when the asynchronous network operation completes, the callback function may be invoked, an exception may be handled, or an interrupt may be handled. At the point when the asynchronous network operation completes (708), operations will continue again by pushing (704) the initial detection operation to the end of an event loop of the IDE 102. Alternatively, if the initial detection operation (706) determines the end state has been reached, then a secondary detection operation is pushed (710) to the end of the event loop of the IDE 102.

When the secondary detection operation (712) is eventually reached in the event loop, the secondary detection operation (712) is performed. The secondary detection operation (712) checks if the end state is reached in the same manner as the initial detection operation (706). As before, if the end state is not yet reached, then operations will wait (708) until an asynchronous network operation completes. However, if the end state is reached, then the end state has been detected twice in a row. Accordingly, the sequence of events is considered ended, and the end state may be considered to have been reached (714).

As explained above, the sequence of detection operations may be started (702) in response to any of the legacy plugins invoking a programmatic method of the common core 120 that transfers data to and/or from the metadata database 110. The programmatic method of the common core 120 that transfers data to and/or from the metadata database 110 may be invoked by multiple legacy plugins before the sequence of detection operations completes. Consequently, the logic shown in FIG. 7 may be executed in multiple instances in parallel.

Stated differently, the idle state 608 of the IDE 102 may be determined to be reached if, for each of the MVA plugins, the MDO view 404 indicates the user input event 414 has been processed and the MDO controller 402 indicates the IDE event 410 has been processed and, for all of the legacy plugins or even all of the plugins generally, there have been two consecutive failures to find, at an end of an event loop of the IDE 102, any pending transfer operation to or from the metadata database 110.

The end state determined as described above may not necessarily always be in view of a wide variety of possible implementations of the legacy plugins. The logic for the determination of the operational state of the IDE 102 is based on a pattern that legacy plugins are likely to follow. For example, with the loading of the metadata document 118 as an example, a general behavior pattern followed by the legacy plugin 124 is:
. . . (loop)→Network request (async)→Data Update (sync) (optional)→Network request (async)→ . . . (loop)→end

Any of the legacy plugins that may cause the end state determination to be incorrect, may be modified to follow the above-identified behavior pattern or re-written to have the structure of the MVA plugin 122. The logic for the determination of the operational state of the IDE 102 also takes advantage of the IDE 102 being single threaded, or at least the execution of the plugins being single threaded.

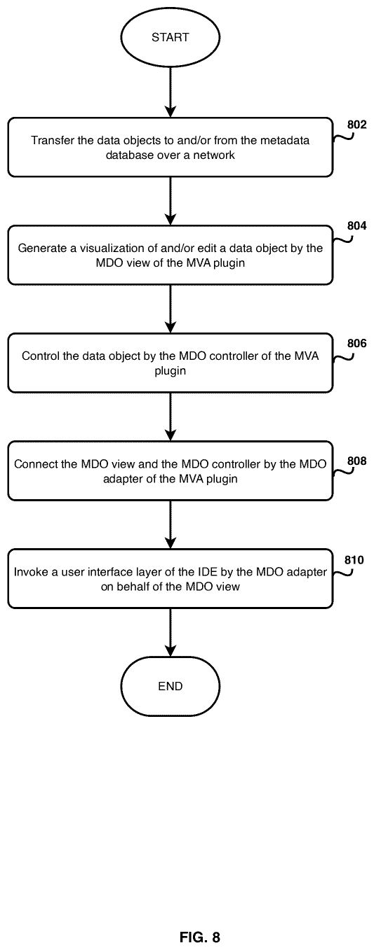

FIG. 8 illustrates a flow diagram of example logic for system for the IDE 102 configured to customize the customizable application 104. The logic may include additional, fewer, and/or different operations than illustrated in FIG. 8.

The operations may include transferring (802), from the IDE 102, the data objects 108 to and/or from the metadata database 110 over the network 116. The transfer of the data objects 108 or a subset thereof may be caused by the MDO controller 402 of the MVA plugin 122.

The MVA plugin 122 may generate (804) a visualization of and/or edit (804) a data object. The MDO view 404 of the MVA plugin 122 may generate the visualization of and/or edit the data object via the MDO adapter 406. The MDO view 404 may handle a user input event received from the MDO adapter 406. In some examples, the generation (804) of the visualization of and/or the editing (804) the data object may be in response to the user input event.

The MDO controller 402 may control (806) the data object in response to the IDE event 410 received from the MDO adapter 406. For example, the MDO controller 402 may read, modify, and/or write the data object.

The MDO adapter 406 may connect (808) the MDO view 404 and the MDO controller 402. In some examples, this may be performed intrinsically by the MDO adapter 406 having a pointer to the MDO view 404 and the MDO controller 402.

The MDO adapter 406 may invoke (810) the user interface layer 126 of the IDE 102 on behalf of the MDO view 404 in the generation of the visualization of the data object.

Operations may end, for example, by the IDE 102 entering the idle state 608.

The system 100 may include more, fewer, or different elements than illustrated. For example, the system 100 may also include the IDE 102, the state management layer 128, the user interface layer 126, and/or the IDE orchestration service 130. In some examples, the system 100 may also include the customizable application 104.

The metadata database 110 may be any database in which the data objects 108 and/or the metadata document 118 may be stored. Examples of the metadata database 110 may include a Relational Database Management System (RDBMS), a graph database, an object-oriented database, an extensible markup language (XML) database, a file, a file system, or other type of database.

The metadata document 118 may be any data structure that includes the data objects 108. Examples of the metadata document 118 may include a file, a portion of a browser's DOM (Document Object Model) tree, a JSON document, or any other suitable data structure. Example formats of the metadata document 118 may include JSON, XML, or any data exchange format.

The IDE 102 may be a desktop application, a mobile application, a web application, or any other type of application having a graphical user interface.

The system 100 may be implemented with additional, different, or fewer components. For example, the system 100 may include a processor 902 and a memory 904. In some examples, the system 100 may include a display 906 and a input device 908. The processor 902, the memory 904, the display 906, and the input device 908 may be included in a computing device 910, such as a laptop computer, a desktop computer, a mobile device, or any other type of computing device.

The processor 902 may be in communication with the memory 904. The processor 902 may also be in communication with additional elements, such as the display 906, and the input device 908. For example, the processor 902 may cause the graphical user interface 103 of the IDE 102 to be displayed on the display 906. Examples of the processor 902 may include a general processor, a central processing unit, a microcontroller, a server, an application specific integrated circuit (ASIC), a digital signal processor, a field programmable gate array (FPGA), and/or a digital circuit, analog circuit.

The processor 902 may be one or more devices operable to execute logic. The logic may include computer executable instructions or computer code embodied in the memory 904 or in other memory that when executed by the processor 902, cause the processor 902 to perform the features implemented by the logic. The computer code may include instructions executable with the processor 902.

The memory 904 may be any device for storing and retrieving data or any combination thereof. The memory may include non-volatile and/or volatile memory, such as a random access memory (RAM or DRAM), solid state memory, flash memory, a read-only memory (ROM), an erasable programmable read-only memory (EPROM), or flash memory. Alternatively or in addition, the memory 904 may include an optical, magnetic (hard-drive) or any other form of data storage device.

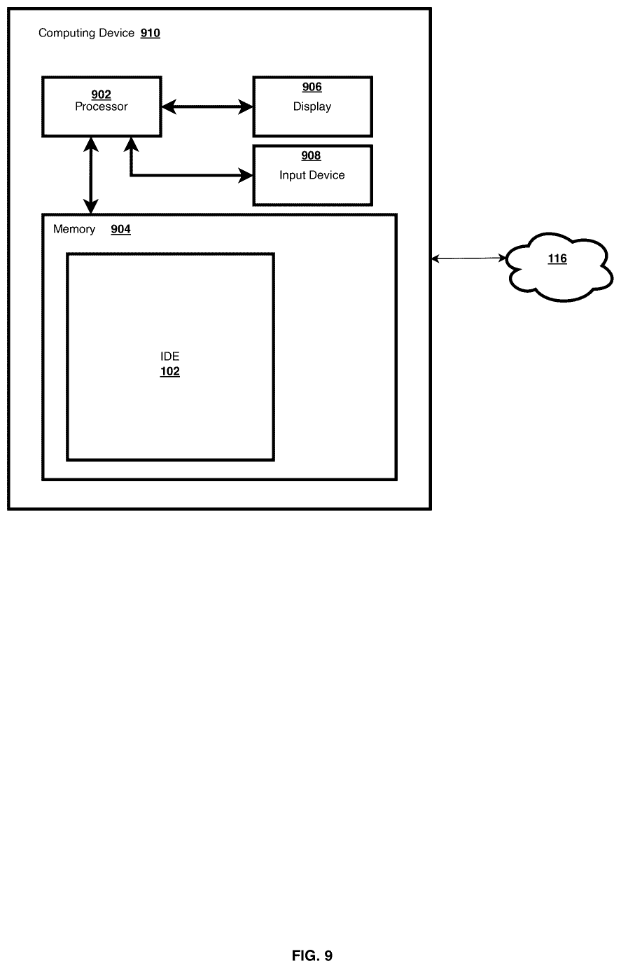

The memory 904 may include any of computer code and/or data structures of the system 100. For example, the memory 904 may include the IDE 102 and code therein as illustrated in FIG. 9. In another example, the memory 904 may include the plugins (for example, the MVA plugin 122 and the legacy plugin 124), the metadata document 118, and the common core 120. Alternatively or in addition, the memory 904 may include the user interface layer 126, the state management layer 128, and the IDE orchestration service 130.

The system 100 may be implemented in many different ways. Each module, such as the plugins 122 and 124 and the common core 120, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of the memory 904, for example, that comprises instructions executable with the processor 902 or other processor to implement one or more of the features of the module. When any one of the modules includes the portion of the memory that comprises instructions executable with the processor, the module may or may not include the processor. In some examples, each module may just be the portion of the memory 904 or other physical memory that comprises instructions executable with the processor 902 or other processor to implement the features of the corresponding module without the module including any other hardware. Because each module includes at least some hardware even when the included hardware comprises software, each module may be interchangeably referred to as a hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, flash memory, or any other suitable tangible storage device.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL)).

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action includes setting a Boolean variable to true and the second action is initiated if the Boolean variable is true.

The subject-matter of the disclosure may also relate, among others, to the following aspects:

A first aspect relates to a system for an integrated development environment (IDE) configured to customize a customizable application, the system comprising a processor and a memory, the memory including: a metadata document comprising a plurality of data objects, the data objects comprising properties, wherein application logic of the customizable application is configured to customize aspects of the customizable application based on the data objects stored in a metadata database; a state management layer executable by the processor to manage an application state of the IDE, the application state including the metadata document; a user interface layer executable by the processor to generate a graphical user interface for the IDE; a common core executable by the processor to transfer the data objects to and/or from the metadata database; and a model-view-adapter (MVA) plugin for a data object type, the MVA plugin executable by the processor to generate a visualization of and/or edit a data object of the data object type, the data object included in the data objects of the metadata document, the MVA plugin comprising a MDO controller, a MDO view, and a MDO adapter, wherein the MDO controller is executable by the processor to control the data object in response to an IDE event received from the MDO adapter, wherein the MDO view is executable by the processor to handle a user input event received from the MDO adapter and to generate the visualization of the data object via the MDO adapter, wherein the MDO adapter is executable with the processor to: connect the MDO view and the MDO controller; provide events and data to the MDO view and the MDO controller; invoke the user interface layer on behalf of the MDO view for the visualization of the data object; receive plugin events from the state management layer; transfer the data object to and/or from the state management layer; and transfer the data object to and/or from the metadata database via the common core.

A second aspect relates to the system of aspect 1, wherein the data object is a first data object, the data object type is a first data object type, and the data objects includes a second data object of a second data object type, wherein the system further comprises a legacy plugin, the legacy plugin for the second data object type, wherein the legacy plugin is executable by the processor to: generate a visualization of and/or edit the second data object directly via the user interface layer; transfer the second data object directly to and/or from the state management layer; and transfer the data object to and/or from the metadata database via the common core.

A third aspect replates to the system of aspect 2, wherein the common core is executable with the processor to: determine an idle state of the IDE, wherein the idle state of the IDE is an operational state in which the IDE is ready to receive user inputs, and user input events related to updating the data objects 108 or the metadata document have completed, wherein the idle state of the IDE is determined to be reached if the MDO view indicates the user input event has been processed and the MDO controller indicates the IDE event has been processed and if two consecutive failures to find, at an end of an event loop of the IDE, any pending transfer operation to or from the metadata database.

A fourth aspect relates to the system of any preceding aspect, wherein the metadata document is a JSON document.

A fifth aspect relates to the system of any preceding aspect, wherein the user interface layer is React.

A sixth aspect relates to the system of any preceding aspect, wherein the state management layer is Redux.

A seventh aspect relates to the system of any preceding aspect wherein the IDE is a web application.

An eighth aspect relates to a non-transitory computer readable storage medium comprising computer executable instructions, the computer executable instructions executable by a processor, the computer executable instructions comprising: a common core executable to transfer a plurality of data objects to and/or from a metadata database over a network, wherein the common core is executable within an integrated development environment (IDE) configured to customize a customizable application, wherein application logic of the customizable application is configured to customize aspects of the customizable application based on the data objects stored in the metadata database; a model-view-adapter (MVA) plugin for the IDE, the MVA plugin executable to generate a visualization of and/or edit a data object of a data object type, the data object included in the data objects, the MVA plugin comprising a MDO controller, a MDO view, and a MDO adapter, wherein the MDO controller is executable to control the data object in response to an IDE event received from the MDO adapter, wherein the MDO view is executable to handle a user input event received from the MDO adapter and to generate the visualization of the data object via the MDO adapter, wherein the MDO adapter is executable to: connect the MDO view and the MDO controller; provide events and data to the MDO view and the MDO controller; invoke a user interface layer of the IDE on behalf of the MDO view for the visualization of the data object; and transfer the data object to and/or from the metadata database via the common core.

A ninth aspect relates to the computer readable storage medium of aspect 8, wherein the MDO adapter is further executable to: receive plugin events from a state management layer of the IDE, wherein the state management layer is responsible for writes and reads to and from a metadata document, the metadata document including the data objects; and transfer the data object to and/or from the state management layer.

A tenth aspect relates to the computer readable storage medium of aspect 9, wherein the MDO controller includes a data API having a programmatic method configured to be invoked in response to the metadata document being loaded.

An eleventh aspect relates to the computer readable storage medium of aspect 9, wherein the MDO controller includes a data API having a programmatic method configured to be invoked in response to an update to the metadata document.

A twelfth aspect relates to the computer readable storage medium of any preceding aspect, wherein the MDO controller includes a data API having one or more programmatic methods corresponding to one or more events and/or sub-events specific to the data objects and/or a metadata document, the metadata document including the data objects.

A thirteenth aspect relates to the computer readable storage medium of aspect 12, wherein the common core is further executable to determine an idle state of the IDE, wherein the idle state of the IDE is an operational state of the IDE in which the IDE is ready to receive user inputs, and invocations of the one or more programmatic methods corresponding to one or more events and/or sub-events specific to the data objects have completed.

A fourteenth aspect relates to the computer readable storage medium of aspect 13, wherein the idle state of the IDE is determined to be reached after an additional condition is met, the additional condition being a detection of two consecutive failures to find, at an end of an event loop of the IDE, any pending transfer operation to or from the metadata database.

A fifteenth aspect relates to a computer-implemented method the method comprising: transferring, from an integrated development environment (IDE) configured to customize a customizable application, a plurality of data objects to and/or from a metadata database over a network, wherein application logic of the customizable application is configured to customize aspects of the customizable application based on the data objects stored in the metadata database; generating a visualization of and/or editing a data object by a model-view-adapter (MVA) plugin for the IDE, the data object included in the data objects, the MVA plugin comprising a MDO controller, a MDO view, and a MDO adapter; controlling, by the MDO controller, the data object in response to an IDE event received from the MDO adapter, wherein the MDO view generates the visualization of and/or edits the data object via the MDO adapter, and the MDO view handles a user input event received from the MDO adapter; connecting the MDO view and the MDO controller by the MDO adapter; invoking a user interface layer of the IDE by the MDO adapter on behalf of the MDO view for the visualization of the data object; and causing, by the MDO adapter on behalf of the MDO controller, the transfer of the data object to and/or from the metadata database.

A sixteenth aspect relates to the method of aspect 15 further comprising determining if the IDE is in an idle state, wherein the idle state of the IDE is an operational state of the IDE in which the IDE is ready to receive user inputs, and user input events related to updating the data objects and a metadata document have completed, the metadata document including the data objects.

A seventeenth aspect relates to the method of aspect 16, wherein determining if the IDE is in an idle state comprises: pushing an initial detection operation to an end of an event loop of the IDE; determining an end state is not reached during a first execution of the initial detection operation; waiting for a pending asynchronous network operation to complete in response to determining the end state was not reached during the first execution of the initial detection operation; pushing the initial detection operation to the end of the event loop of the IDE in response to the pending asynchronous network operating completing; determining the end state is reached during a second execution of the initial detection operation; pushing a secondary detection operation to the end of the event loop of the IDE in response to determining the end state was reached during execution of the secondary detection operation; determining the end state is reached during an execution of the secondary detection operation; and determining the IDE is in the idle state in response to determining the end state was reached during the execution of the secondary detection operation.

An eighteenth aspect relates to the method of aspect 17, wherein determining the end state is reached includes determining the user input events related to updating the data objects and the metadata document have completed.

A nineteenth aspect relates to the method of aspect 18, wherein determining the end state is reached further includes determining no asynchronous network operations to the metadata database are pending.

A twentieth aspect relates to the method of preceding aspect, wherein the IDE is a web application.

In addition to the features mentioned in each of the independent aspects enumerated above, some examples may show, alone or in combination, the optional features mentioned in the dependent aspects and/or as disclosed in the description above and shown in the figures.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various examples have been described, it will be apparent to those of ordinary skill in the art that many more examples and implementations are possible. Accordingly, the examples and implementations described herein are descriptive, but not the only possible examples and implementations.

What is claimed is:

1. A system for an integrated development environment (IDE) configured to customize a customizable application, the system comprising a processor and a memory, the memory including:
a metadata document comprising a plurality of data objects, the data objects comprising properties, wherein application logic of the customizable application is configured to customize aspects of the customizable application based on the data objects stored in a metadata database;
a state management layer executable by the processor to manage an application state of the IDE, the application state including the metadata document;
a user interface layer executable by the processor to generate a graphical user interface for the IDE;
a common core executable by the processor to transfer the data objects to and/or from the metadata database; and
a model-view-adapter (MVA) plugin for a data object type, the MVA plugin executable by the processor to generate a visualization of and/or edit a data object of the data object type, the data object included in the data objects of the metadata document, the MVA plugin comprising a MDO controller, a MDO view, and a MDO adapter, wherein the MDO controller is executable by the processor to control the data object in response to an IDE event received from the MDO adapter, wherein the MDO view is executable by the processor to handle a user input event received from the MDO adapter and to generate the visualization of the data object via the MDO adapter, wherein the MDO adapter is executable with the processor to:
connect the MDO view and the MDO controller;
provide events and data to the MDO view and the MDO controller;
invoke the user interface layer on behalf of the MDO view for the visualization of the data object;
receive plugin events from the state management layer;
transfer the data object to and/or from the state management layer; and
transfer the data object to and/or from the metadata database via the common core.

2. The system of claim 1, wherein the data object is a first data object, the data object type is a first data object type, and the data objects includes a second data object of a second data object type, wherein the system further comprises a legacy plugin, the legacy plugin for the second data object type, wherein the legacy plugin is executable by the processor to:
generate a visualization of and/or edit the second data object directly via the user interface layer;
transfer the second data object directly to and/or from the state management layer; and
transfer the data object to and/or from the metadata database via the common core.

3. The system of claim 2, wherein the common core is executable with the processor to:
determine an idle state of the IDE, wherein the idle state of the IDE is an operational state in which the IDE is ready to receive user inputs, and user input events related to updating the data objects 108 or the metadata document have completed,
wherein the idle state of the IDE is determined to be reached if the MDO view indicates the user input event has been processed and the MDO controller indicates the IDE event has been processed and if two consecutive failures to find, at an end of an event loop of the IDE, any pending transfer operation to or from the metadata database.

4. The system of claim 1, wherein the metadata document is a JSON document.

5. The system of claim 1, wherein the user interface layer is React.

6. The system of claim 1, wherein the state management layer is Redux.

7. The system of claim 1, wherein the IDE is a web application.

8. A non-transitory computer readable storage medium comprising computer executable instructions, the computer executable instructions executable by a processor, the computer executable instructions comprising:
a common core executable to transfer a plurality of data objects to and/or from a metadata database over a network, wherein the common core is executable within an integrated development environment (IDE) configured to customize a customizable application, wherein application logic of the customizable application is configured to customize aspects of the customizable application based on the data objects stored in the metadata database;
a model-view-adapter (MVA) plugin for the IDE, the MVA plugin executable to generate a visualization of and/or edit a data object of a data object type, the data object included in the data objects, the MVA plugin comprising a MDO controller, a MDO view, and a MDO adapter, wherein the MDO controller is executable to control the data object in response to an IDE event received from the MDO adapter, wherein the MDO view is executable to handle a user input event received from the MDO adapter and to generate the visualization of the data object via the MDO adapter, wherein the MDO adapter is executable to:
connect the MDO view and the MDO controller;
provide events and data to the MDO view and the MDO controller;
invoke a user interface layer of the IDE on behalf of the MDO view for the visualization of the data object; and
transfer the data object to and/or from the metadata database via the common core.

9. The computer readable storage medium of claim 8, wherein the MDO adapter is further executable to:
receive plugin events from a state management layer of the IDE, wherein the state management layer is responsible for writes and reads to and from a metadata document, the metadata document including the data objects; and
transfer the data object to and/or from the state management layer.

10. The computer readable storage medium of claim 9, wherein the MDO controller includes a data API having a programmatic method configured to be invoked in response to the metadata document being loaded.

11. The computer readable storage medium of claim 9, wherein the MDO controller includes a data API having a programmatic method configured to be invoked in response to an update to the metadata document.

12. The computer readable storage medium of claim 8, wherein the MDO controller includes a data API having one or more programmatic methods corresponding to one or more events and/or sub-events specific to the data objects and/or a metadata document, the metadata document including the data objects.

13. The computer readable storage medium of claim 12, wherein the common core is further executable to determine an idle state of the IDE, wherein the idle state of the IDE is an operational state of the IDE in which the IDE is ready to receive user inputs, and invocations of the one or more programmatic methods corresponding to one or more events and/or sub-events specific to the data objects have completed.

14. The computer readable storage medium of claim 13, wherein the idle state of the IDE is determined to be reached after an additional condition is met, the additional condition being a detection of two consecutive failures to find, at an end of an event loop of the IDE, any pending transfer operation to or from the metadata database.

15. A computer-implemented method the method comprising:
transferring, from an integrated development environment (IDE) configured to customize a customizable application, a plurality of data objects to and/or from a metadata database over a network, wherein application logic of the customizable application is configured to customize aspects of the customizable application based on the data objects stored in the metadata database;
generating a visualization of and/or editing a data object by a model-view-adapter (MVA) plugin for the IDE, the data object included in the data objects, the MVA plugin comprising a MDO controller, a MDO view, and a MDO adapter;
controlling, by the MDO controller, the data object in response to an IDE event received from the MDO adapter,
wherein the MDO view generates the visualization of and/or edits the data object via the MDO adapter, and the MDO view handles a user input event received from the MDO adapter;
connecting the MDO view and the MDO controller by the MDO adapter;
invoking a user interface layer of the IDE by the MDO adapter on behalf of the MDO view for the visualization of the data object; and
causing, by the MDO adapter on behalf of the MDO controller, the transfer of the data object to and/or from the metadata database.

16. The method of claim 15 further comprising determining if the IDE is in an idle state, wherein the idle state of the IDE is an operational state of the IDE in which the IDE is ready to receive user inputs, and user input events related to updating the data objects and a metadata document have completed, the metadata document including the data objects.

17. The method of claim 16, wherein determining if the IDE is in an idle state comprises:
pushing an initial detection operation to an end of an event loop of the IDE;
determining an end state is not reached during a first execution of the initial detection operation;
waiting for a pending asynchronous network operation to complete in response to determining the end state was not reached during the first execution of the initial detection operation;
pushing the initial detection operation to the end of the event loop of the IDE in response to the pending asynchronous network operating completing;
determining the end state is reached during a second execution of the initial detection operation;
pushing a secondary detection operation to the end of the event loop of the IDE in response to determining the end state was reached during execution of the secondary detection operation;
determining the end state is reached during an execution of the secondary detection operation; and
determining the IDE is in the idle state in response to determining the end state was reached during the execution of the secondary detection operation.

18. The method of claim 17, wherein determining the end state is reached includes determining the user input events related to updating the data objects and the metadata document have completed.

19. The method of claim 18, wherein determining the end state is reached further includes determining no asynchronous network operations to the metadata database are pending.

20. The method of claim 15, wherein the IDE is a web application.
